(19) United States
(12) Patent Application Publication
(10) Pub. No.: US 2006/0146865 A1
(43) Pub. Date: Jul. 6, 2006

(54) Adaptive clock recovery scheme

(76) Inventors: Martin Richard Crowle, Devon (GB); Timothy Michael Edmund Frost, Devon (GB); Robertius Laurentius Van Der Valk, Capelle aan den Ussel (NL)

Correspondence Address: DUANE MORRIS LLP, 1667 K. STREET, N.W., SUITE 700, WASHINGTON, DC, 20006-1608, US

(21) Appl. No.: 11/290,527

(22) Filed: Dec. 1, 2005

(30) Foreign Application Priority Data
Dec. 8, 2004 (GB) 0426899.1

(51) Int. Cl. H04L 12/66

(52) U.S. Cl. 370/463

(57) ABSTRACT

A method of preparing packets for injection into a packet network at an ingress interface of the packet network, for transmission over the network. The method comprises, at the ingress interface, receiving at least two parallel, constant bit rate streams of data, and separately packetising the constant bit rate streams to generate respective packet flows for forwarding to a packet sender. The frequency of at least one of the packet flows with respect to another packet flow is set so as to reduce the degree of correlation between the packet flows, and the packet flows sent to the same or different egress interfaces over the packet network.

### FIELD OF THE INVENTION

The present invention relates to an adaptive clock recovery scheme involving a packet network. The invention is applicable in particular, though not necessarily, to the synchronisation of clocks associated with time division multiplexed transmission links interconnected by a packet network.

### BACKGROUND OF THE INVENTION

Communication networks typically make use of one of two well established transmission mechanisms; circuit switched transfer and packet switched (or just packet) transfer. Older systems tend to use the former, and in the main use time division multiplexing to divide the time domain, for a given frequency band, into time slots of equal duration. Circuits are defined by grouping together identical slot positions in successive time frames. Packet networks typically do not allocate fixed resources to transmitters, but rather route packets of data on a best efforts basis, using destination address information contained in packet headers, and network switches and routers. Packet networks are becoming more popular amongst network operators as they often provide better performance, and are more cost effective to install and maintain, than equivalent circuit switched networks.

Traditionally, telecommunication networks have made use of time division multiplexed (TDM) circuits to interconnect network switches (or exchanges). However, for the above mentioned reasons of performance and cost, many operators and leased line providers (who provide bandwidth to service providers) are moving towards replacing TDM circuits with packet networks. In many cases, switch to switch “sessions” will be provided entirely over packet networks. However, it is likely that for many years to come, some operators will continue to rely upon TDM circuits to provide all or at least a part of the networks. This will necessitate interworking between packet networks and TDM “legacy” equipment.

FIG. 1 illustrates schematically a carrier network 1 which is a packet switched network such as an Ethernet, ATM, or IP network. The carrier network provides leased line services to interconnect first and second customer premises 2,3, both of which make use of TDM transmitters 4,5 to handle multiple information streams. The nature of these streams is unimportant, although they could for example be voice calls, videoconference calls, or data calls. In order to facilitate the interconnection of the TDM streams, the carrier network 1 must emulate appropriate TDM circuits.

TDM links are synchronous circuits with a constant (transmission) bit rate governed by a service clock operating at some predefined frequency. In contrast, in a packet network there is no direct link between the frequency at which packets are sent from an ingress port and the frequency at which they arrive at an egress port. With reference again to FIG. 1, in order to provide TDM circuit emulation, interface nodes 6,7 at the edges of the packet network must provide interworking between the TDM links and the packet network in such a way that the TDM link at the egress side is synchronised with the TDM link at the ingress side. That is to say that the TDM service frequency (f_{service}) at the customer premises on the ingress side must be exactly reproduced at the egress of the packet network (f_{regen}). The consequence of any long-term mismatch in these frequencies will be that the queue at the egress of the packet network will either fill up or empty, depending upon on whether the regenerated clock (f_{regen}) is slower or faster than the original clock (f_{service}), causing loss of data and degradation of the service. Also, unless the phase of the original clock (f_{service}) is tracked by that of the regenerated clock (f_{regen}), the lag in frequency tracking will result in small but nonetheless undesirable changes to the operating level of the queue at the egress.

Some reliable method for synchronising both the frequency and phase of the clock at the egress of a packet network to those of the clock at the TDM transmitted must be provided. One approach is to use some algorithm to recover the transmitting clock frequency and phase from timestamps incorporated into packets by the sender, taking into account the transmission delay over the packet network. As the transmission time over the packet network is unpredictable for any given packet, an adaptive algorithm might be used. For example, some form of averaging might be employed to take into account variations in the transmission delay. For ATM, ITU standard I.363.1 and ATM Forum standard af-vtoa-0078 explain the concept of an adaptive clock recovery mechanism in general terms.

EP1455473 discloses a method of synchronising first and second clocks coupled respectively to ingress and egress interfaces of a packet network, where the first clock determines the bit rate of a constant bit rate TDM stream arriving at the ingress interface and the second clock rate determines the bit rate of a constant bit rate TDM stream sent from the egress interface. The method comprises calculating a minimum packet Transit Time over the network in each of successive time intervals, and varying the frequency of the second clock so as to maintain a constant value of the calculated minimum packet transit time and hence achieve both phase and frequency synchronisation of the first and second clocks. The underlying principle of the described method is that, almost regardless of the level of traffic in a packet network, a proportion of packets will always be transmitted with the same fixed minimum transit time value. The method is applicable in particular for synchronising a clock of a TDM sending entity coupled to the egress interface, to a clock of a TDM link coupled to the ingress interface.

EP1455473 is concerned with synchronising the TDM clocks at the ingress and egress of the packet network which are associated with a given TDM stream. The method may be applied in parallel to a number of TDM streams sent between the same ingress and egress interfaces. The clocks and synchronisation procedures of each stream are treated independently.

### SUMMARY OF THE INVENTION

The present invention derives from the observation that the delays suffered by packets belonging to a given stream will be influenced by the presence of other streams at the same ingress interface to a packet network, or otherwise intersecting at a common packet network node. This is especially true where the frequencies with which packets are injected into the packet network at the ingress interface, or arriving at a given network node, are similar for different streams.

Consider for example two TDM streams having similar, but slightly different frequencies, i.e. bit rates. For each stream, a “packetiser” at the corresponding ingress interface places bits, as they arrive, into packets of fixed size. The packet size is the same for each stream. The top two streams in FIG. 2 illustrate the respective packet flows.

Where the TDM streams arrive at the same ingress interface, the respective packet flows will “intersect” at the that packet sender of that interface. Where the TDM streams arrive at different ingress interfaces, the packet flows may intersect at some common, intermediate node within the packet network.

At the interface or common node where the packet flows intersect, the forwarding unit is only able to inject one packet at a time into the packet network at the output. It will take packets in sequence as they arrive on the two streams. This is not problematic where packets arriving on the two streams do not overlap. However, when an overlap occurs, the sending of a packet may be delayed, pending the sending of a packet which arrived momentarily earlier for the other stream. This situation is illustrated in the lower sequence of FIG. 2.

As an example of this effect, consider the case where two packet streams have a nominal packet rate of 1 khz but are actually 1 ppm offset from each other. The transmission time for a 318 byte packet over a 100 Mbit/s network is 26.4 μs. The beat period for the disruption is 1000 s, and the timing is disrupted for 26.4 s

It will be appreciated that for streams having identical frequencies, any resulting delays will be fixed, and will not effect the synchronisation of the ingress and egress clocks. However, very small differences in frequency will have a relatively long-lasting effect on the delays suffered by packets. Assuming that the minimum packet Transit Time method of EP1455473 is employed, the correlation between packet flows will result in a change in the minimum transit time determined by the egress interface which is not due to any loss of synchronisation of the ingress and egress clocks, and which is only very slowly varying and therefore not cancelled by the low pass filtering of minimum transit time values carried out at the egress. The egress interface will, wrongly, adjust the egress clock in an attempt to restore the apparent phase and frequency difference between the ingress and egress clocks. The result could be a phase error equal to the magnitude of the disruption, eg. which would be 26.4 us for the example above.

The problem of a loss of synchronisation will arise for other similar clock synchronisation procedures, e.g. an averaging clock recovery scheme.

According to a first aspect of the present invention there is provided a method of preparing packets for injection into a packet network at an ingress interface of the packet network, for transmission over the network, the method comprising:

at the ingress interface, receiving at least two parallel, constant bit rate streams of data;

separately packetising the constant bit rate streams to generate respective packet flows for forwarding to a packet sender;

setting the frequency of at least one of the packet flows with respect to another packet flow so as to reduce the degree of correlation between the packet flows; and

sending the packet flows to the same or different egress interfaces over the packet network.

Embodiments of the invention result in the significant advantage that the correlation between the packet flows arriving at the sender is reduced. The probability that packets on different flows will overlap for prolonged periods is thereby reduced. While overlaps may still occur, these are likely to be isolated events, or to continue only for a relatively short sequence of packets. The effects of such variations can be removed by low pass filtering or data selection techniques at the egress interface.

In a particular embodiment of the present invention, said ingress and egress interfaces are interfaces between the packet network and incoming and outgoing Time Division Multiplex (TDM) circuits.

The method may comprise determining the clock frequencies of each incoming bit stream at the ingress interface, or of each packet flow, and changing a packet flow frequency for a stream only if the frequency of that flow or stream differs from the frequency of another stream or packet flow by a value which is less than some predefined value, and/or is not exactly synchronised with the frequency of another stream or packet flow.

According to a second aspect of the present invention there is provided a method of preparing packets for injection into a packet network at an ingress interface of the packet network, for transmission over the network to one or more egress interfaces, the method comprising:

at the ingress interface, receiving a packet flow obtained from a constant bit rate stream of data; and

dynamically changing the frequency of the packet flow so as to reduce the degree of correlation between that flow and other packet flows over the packet network.

A number of options for changing the frequency of a packet flow exist. These include, without limitation:

Introducing a fixed change in the packet size of a given flow;

Dynamically varying the packet size of a given flow. The variation may be random, in order to increase the resilience to prolonged correlation of the packet flow to other packet flows;

Changing the packet size according to a pseudo-random sequence;

Deliberately introducing a delay into the packets of a packet flow; and

Applying a change to the bit rate of a constant bit rate stream.

These options may be employed separately or in combination.

According to a third aspect of the present invention there is provided a method of synchronising first and second clocks coupled respectively to ingress and egress interfaces of a packet network, where the first clock determines the bit rate of a constant bit rate stream arriving at the ingress interface and the second clock rate determines the bit rate of a constant bit rate stream sent from the egress interface, the method comprising preparing packets for injection into the packet network at the ingress interface according to the above first or second aspect of the invention.

The method preferably comprises, at the egress interface, calculating a minimum packet Transit Time over the network in each of successive time intervals, and varying the frequency of the second clock so as to maintain a constant value of the calculated minimum packet transit time and hence achieve frequency and phase synchronisation of the first and second clocks.

According to a fourth aspect of the present invention there is provided apparatus for preparing packets for injection into a packet network at an ingress interface of a packet network for transmission over the network to one or more egress interfaces, the apparatus comprising:

an input for receiving at least two parallel, constant bit rate streams of data;

first processing means for separately packetising the constant bit rate streams to generate respective packet flows for forwarding to a packet sender; and

second processing means for setting the frequency of at least one of the packet flows with respect to another packet flow so as to reduce the degree of correlation between the packet flows.

According to a fifth aspect of the present invention there is provided apparatus for preparing packets for injection into a packet network at an ingress interface of a packet network for transmission over the network to one or more egress interfaces, the apparatus comprising:

an input for receiving a packet flow obtained from a constant bit rate stream of data;

processing means for dynamically changing the frequency of the packet flow so as to reduce the degree of correlation between that flow and other packet flows over the network.

### BRIEF DESCRIPTION OF THE DRAWINGS

FIG. 1 illustrates schematically the interconnection of two TDM links via a packet network;

FIG. 2 illustrates two packet flows associated with respecting TDM bit streams, and a packet injection stream into a packet network;

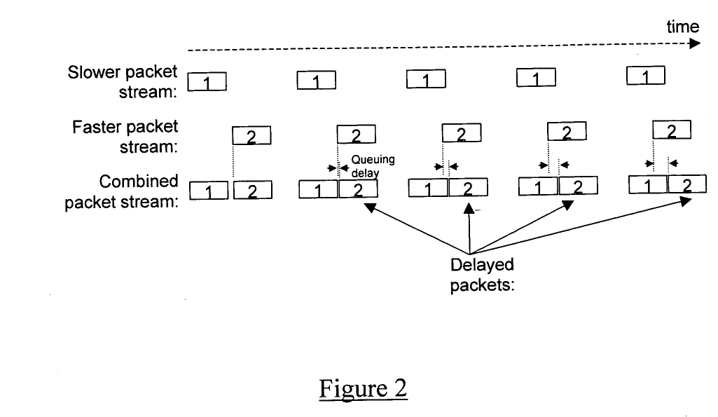

FIG. 3 illustrates an architecture for a destination interface coupling a packet network to a TDM link; and

FIG. 4 illustrates two packet flows associated with respecting TDM bit streams, and a packet injection stream into a packet network, generated in accordance with a first embodiment of the invention;

### DETAILED DESCRIPTION OF CERTAIN EMBODIMENTS

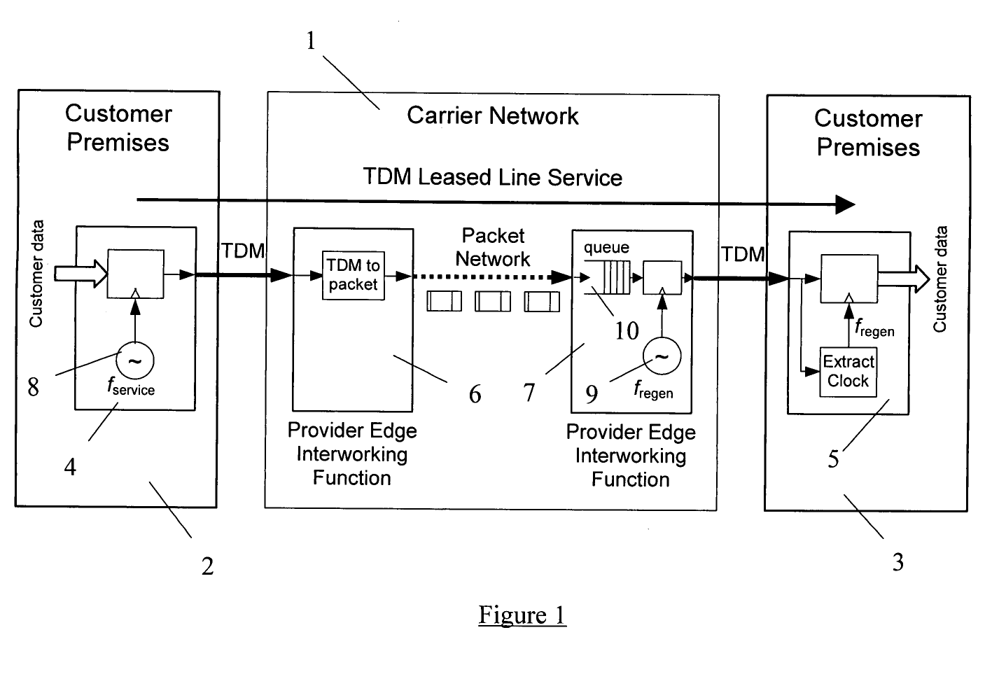

Considering again the scenario illustrated in FIG. 1, where TDM transmitters 4,5 located at respective customer premises 2,3 are coupled via TDM links to interface nodes 6,7 of a carrier network 1, for each TDM link, the basic rate of transmission of packets from the source or “ingress” interface 6 is isochronous and determined by a service frequency (f_{service}) provided for example by a suitable Oscillator 8. However, the rate of packet arrival at the destination interface 7 is perturbed by the intervening packet network. Packets will typically arrive in bursts separated by varying amounts of delay. The delay between successive packets and bursts will vary for example depending on the amount of traffic in the network. The characteristics of the network are non-deterministic, but over the long term the rate of arrival at the destination will equal the rate of departure from the source.

At the source interface 6, a timestamp is placed into the header of each packet prior to transmission. This timestamp is referred to here as the “Remote Timestamp”, and is a running total of the bits received on the incoming TDM link since initialisation (wrap around of this count will occur to avoid counter overflow).

The TDM output at the destination interface 7 is isochronous and determined by a second service frequency, referred to here as the “regeneration” frequency (f_{regen}). This is provided by a Digitally Controlled Oscillator (DCO) 9. The destination interface output is supplied from a Packet Delay Variation (PDV) buffer 10. If the buffer 10 has zero packets in it when the TDM output requires to transmit, an underrun will occur, which is undesirable. In order to minimise underrun events it is necessary to build up the PDV buffer 10 so that it contains sufficient packets to supply the TDM output for the majority of inter packet delays. However, the PDV buffer 10 cannot be made arbitrarily large because this directly increases the end to end latency which, in general, is required to be as low as possible, the maximum tolerable latency being dependent on the application. For example, voice typically requires lower latency than data.

When a packet arrives at the packet input of the destination interface 7, the packet is placed into a queue of the PDV buffer 10. The Remote Timestamp is extracted from the packet and is passed to a differencer. The destination interface 7 maintains a TDM output counter which is a running total of the bits sent on the outgoing TDM link—this counter is initialised to the first received Remote Timestamp. A Local Timestamp is obtained for the received packet using this counter, and this is also provided to the differencer. The differencer subtracts the Remote Timestamp from the Local Timestamp to obtain a Transit Time:
Transit Time(n)=Remote Timestamp(n)−Local Timestamp(n)
where n is a packet sequence number. It should be noted that because the source and destination clock frequencies and initial counts (i.e. origins) are not precisely synchronised with respect to each other, the Transit Time in this equation does not represent the actual time that the packet has taken to travel between the source and destination interfaces 6,7. However, it is true that, given an ideal fixed delay packet network, the Transit Time will decrease if f_{service} exceeds f_{regen}, will increase if f_{regen} exceeds f_{service}, and will remain constant if these frequencies are identical. Therefore, variations in Transit Time values will be caused by relative offset and/or drift between the source and destination clock frequencies, and also by variation in the delay experienced by each packet as it passes through the packet network.

In a packet network, most of the transmission delay is caused by waiting time in queues at output ports of switches and routers. However, a proportion of packets will not be held up in any queues, i.e. they will just happen to arrive at each switch at a time when there are no other packets queued up. These packets will experience only a minimum delay, the value of which is largely independent of network loading, being due to factors such as cumulative line propagation delays and service delays at each switch.

If the network loading varies, the average packet transmission delay over the packet network will also vary. However, the minimum delay should not vary to the same extent. Therefore identifying the minimum packet delay within each of successive time periods should give the required indication of drift between the source and destination clock frequencies, independent of changes in network loading. This is very important where such changes in loading occur at a relatively low frequency, for example a 24 hour cycle. Such low frequency variations may be indistinguishable from source clock frequency drift which must be followed by the clock recovery system.

In a typical implementation, for every packet received at the destination interface, a Transit Time is calculated. Over some given period referred to as the “clock control interval”, e.g. 1 second, the minimum Transit Time is determined. The minimum Transit Time is reset for each new time period. Immediately after the expiry of a time period, a clock control algorithm will read the minimum Transit Time recorded for that period, determine the correction required to the destination interface clock frequency, and write the required frequency to the DCO of the destination interface. The clock control interval will generally be relatively large compared to the (transmission and arrival) intervals between packets so that the minimum Transit Time that the algorithm reads will be the minimum of a large set of Transit Time values.

A suitable clock control algorithm is given by the following difference equation:
Fₘ=Fₘ₋₁+G1(Yₘ−Yₘ₋₁)+G2(Yₘ−TransitTarget)

Where:

Fₘ is the Frequency to be written to the DCO of the destination interface;

G1,G2 are constants that determine the dynamic behaviour;

Fₘ₋₁, is the Current DCO Frequency;

Yₘ is the minimum Transit Time;

TransitTarget is the desired target time for the Transit Time; and

m is a sample number that increments each time the clock control algorithm reads the minimum Transit Time.

The constants G1 and G2 determine the frequency response of the system and are selected to track long term drift in f_{service} but reject short-term variation due to packet delay variations.

A further term may optionally be added to the above equation. This makes use of an Offset constant which can be used during operation to adjust the operating point (i.e. fill level) of the PDV buffer to a new value. This may be desirable in order to cope with changing network conditions which cause the buffer to empty (or overflow). A filter function, such as a first order filter, may be used to provide a filtered measurement of the PDV buffer fill level. The clock control algorithm can then be expanded to read the filtered level, and set the Offset accordingly.

This system is robust in the presence of lost packets because the Remote and Local Timestamps of the next packet received following any lost packet(s) are unaffected by the loss. The lost packets merely represent a short term loss of resolution in the measurement. In a typical system there will be thousands of packets per second so that even a packet loss rate which is at or close to the maximum (i.e. a few percent) will have a negligible effect on the result.

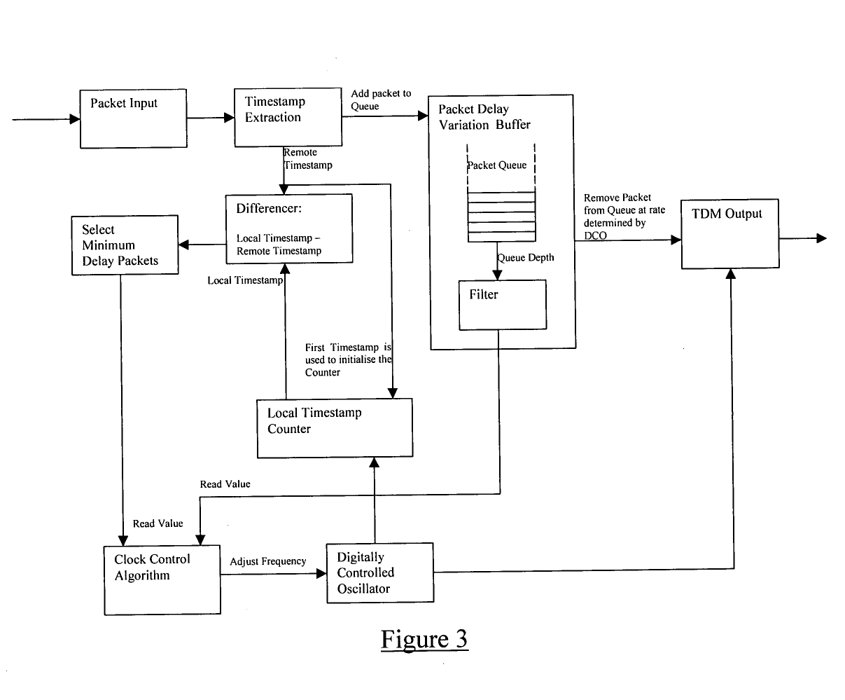

FIG. 3 illustrates schematically the clock recovery process described above incorporated into the destination interface architecture. This is essentially the procedure described in EP1455473. Modifications and improvements to the procedure are set out in that document.

As has been noted above, if significant correlation occurs between packet flows associated with respective TDM streams, at the ingress interface 6, packets of one or more streams can be subject to slowly varying delays which will impact significantly on the accuracy with which the output clock(s) can be synchronised. In order to overcome this problem, it is proposed here to introduce differences into the packet transmission frequency for each data stream so that they are no longer correlated. This may be achieved for constant bit rate data streams by arranging that each of the TDM data streams utilises a different, fixed packet size. The packet rate is dependent on the packet size as follows:
data_stream_packet_rate=data_bit_rate/packet_size_in_bits

A larger packet size will reduce the packet flow frequency and vice versa Packet overlap will still have the same probability of occurring, however the distribution of this overlap is now randomised rather than periodic and hence the frequency is higher and more readily removed at the egress interface.

There may be practical limitations on how many different frequencies can be realised using this approach alone, and with large numbers of data streams this may not be sufficient to overcome the potential problems. In this case, the technique may be extended by dynamically changing the packet size for a given stream to provide a much increased resilience to prolonged correlation with other data streams. The interval for changing the packet size for each data stream can be randomised for further effect. The packet size may be changed using a pseudo-random sequence to select from a range of relative primes (that is they are not absolute primes, but are relatively so and will not result in any frequencies that correlate). For example, intervals of two and four would be unsuitable as the packet rate for two would be twice that for four and hence all of the four packets could potentially be blocked. Three and four would be a better choice of intervals.

For the Circuit Emulation Service (CES) scenario illustrated in FIG. 1, an example configuration used to emulate 32 streams of TDM at 2.048 Mbps would typically utilise a per packet payload size of 256 bytes. This gives a nominal packet rate of 1 kHz for each stream. The procedure may assign a pool of packet sizes, which for example could be 256 to 287 bytes, giving the range of packet rates illustrated in Table 1 below. Each stream payload size is adjusted after a random interval to a size randomly selected from the range available.

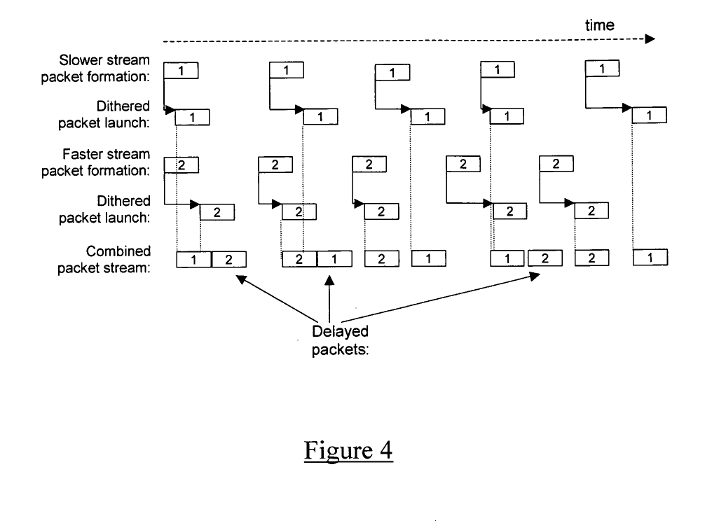

Another approach is to deliberately introduce delays to the packets generated for a given data stream, in order to further randomise the packet frequency. This is illustrated in the flows of FIG. 4, which shows the effect of adding a delay during packet transmission at the ingress node. It can be seen that the disruption to the packet flow is no longer systematic. These two approaches, i.e. changing packet size and deliberately introducing delays into packet flows, will introduce variation to the frequency on a low and high frequency basis respectively, and can be combined for improved performance. An advantage of the combination approach is that the range of launch time dithering required is much smaller and simpler to realise than if the packet rates arriving at the packet sender are correlated to a significant extent. The range of dithering available decreases as port utilisation increases.

It will be apparent from the above discussion that an alternative means to vary the packet rate for a given stream is to change the fundamental bit rate of the emulated TDM link. This approach may be limited by constraints on the data rate however, but could offer further benefits when combined with the other procedures described. The variation to the fundamental data rates may be static or dynamic.

In complex networks, many ingress interfaces may be injecting packets simultaneously onto a single packet switched network. The injected flows may intersect at common intermediate nodes within the network. Problems may arise at these intermediate nodes due to correlation of intersecting packet flows. The solution is to dynamically vary the frequency of the flows either at the respective ingress interfaces. As it may not be practical for a given node to know the frequencies of every packet flow in the network, packet flow frequencies may be varied in isolation from one another, e.g. in a random manner, so as to reduce the risk of correlation.

It will be appreciated by the person of skill in the art that various modifications may be made to the above described embodiments without departing from the scope of the present invention. Whilst the embodiments described above have been concerned specifically with emulated TDM circuits, the invention is applicable to timing recovery mechanisms for any data paths over any packet based system or other asynchronous system.

TABLE 1

| Payload size in bytes | Nominal packet frequency (Hz) |
|---|---|
| 256 | 1000 |
| 257 | 996.11 |
| 258 | 992.25 |
| 259 | 988.42 |
| . . . | |
| 287 | 891.99 |

1. A method of preparing packets for injection into a packet network at an ingress interface of said packet network, for transmission over said packet network, said method comprising the steps of:
at said ingress interface, receiving at least two parallel, constant bit rate streams of data;
separately packetizing each of said at least two constant bit rate streams to generate corresponding packet flows, wherein each of said packet flows is comprised of a plurality of packets, for forwarding to a packet sender;
setting a frequency of at least one of said packet flows with respect to a frequency of another one of said packet flows to reduce the degree of correlation between said packet flows; and
sending said packet flows to a same or different egress interface over said packet network.

2. The method according to claim 1, wherein said ingress and egress interfaces are interfaces between said packet network and incoming and outgoing time division multiplex (TDM) circuits, said constant bit rate streams being TDM data streams.

3. The method according to claim 1, further comprising a step of determining clock frequencies of each packet flow, and changing a frequency of a packet flow when said frequency differs from a frequency of an incoming constant bit rate stream or another packet flow by a value which is less than some predefined value, and/or is not exactly synchronised with a frequency of an incoming constant bit rate stream or another packet flow.

4. The method according to claim 3, wherein said step of changing said packet flow frequency comprises introducing a fixed change in a packet size of a given packet flow.

5. The method according to claim 3, wherein said step of changing said packet flow frequency comprises dynamically varying a packet size of a given packet flow.

6. The method according to claim 5, wherein said dynamically varying step involves randomly varying said packet size.

7. The method according to claim 5 wherein said dynamically varying step involves varying said packet size according to a pseudo-random sequence.

8. The method according to claim 3, wherein said step of changing said packet flow frequency comprises deliberately introducing a delay into said packets of a given packet flow with respect to said packets of another packet flow.

9. The method according to claim 8, wherein said delay is varied randomly from packet to packet.

10. The method according to claim 3, wherein said step of changing said packet flow frequency comprises applying a change to a bit rate of one or more of said constant bit rate streams.

11. A method of preparing packets for injection into a packet network at an ingress interface of said packet network, for transmission over said packet network to one or more egress interfaces, the method comprising the steps of:
at the ingress interface packetizing a constant bit rate stream of data to generate a packet flow for transmission over said packet network; and
dynamically changing a frequency of said packet flow so as to reduce the degree of correlation between said packet flow and other packet flows over said packet network.

12. The method according to claim 11, wherein said step of dynamically changing said frequency of said packet flow comprises introducing a step change in a packet size of said packet flow.

13. The method according to claim 11, wherein said step of dynamically changing said frequency of said packet flow comprises dynamically varying a packet size of said packet flow.

14. The method according to claim 13, wherein said dynamically varying said packet size involves randomly varying said packet size.

15. The method according to claim 13, wherein said dynamically varying said packet size involves varying said packet size according to a pseudo-random sequence.

16. The method according to claim 11, wherein said step of dynamically changing said frequency of said packet flow comprises deliberately introducing a delay between said packets of said packet flow.

17. The method according to claim 16, wherein said delay is varied randomly.

18. The method according to claim 11, further comprising the step of synchronizing first and second clocks coupled respectively to said ingress and egress interfaces of said packet network, for each of a plurality of constant bit rate streams, wherein a frequency of said first clock determines a bit rate of a constant bit rate stream arriving at said ingress interface and a frequency of said second clock determines a bit rate of a constant bit rate stream sent from said egress interface.

19. The method according to claim 18 further comprising the step of, at the egress interface, calculating a minimum packet transit time over said packet network in each of successive time intervals, and varying said frequency of said second clock to maintain a constant value of said minimum packet transit time, whereby frequency and phase synchronization of said first and second clocks is achieved.

20. The method according to claim 18 further comprising the step of, at said egress interface, calculating a mean packet arrival rate over said packet network in each of successive time intervals, and varying said frequency of said second clock to maintain a constant value of said mean packet arrival rate, whereby frequency and phase synchronization of said first and second clocks is achieved.

21. Apparatus for preparing packets for injection into a packet network at an ingress interface of said packet network for transmission over said packet network to one or more egress interfaces, said apparatus comprising:
an input for receiving at least two parallel, constant bit rate streams of data;
first processing means for separately packetizing said constant bit rate streams to generate corresponding packet flows for forwarding to a packet sender; and
second processing means for setting a frequency of at least one of said packet flows with respect to a frequency of another packet flow to reduce the degree of correlation between the packet flows.

22. Apparatus for preparing packets for injection into a packet network at an ingress interface of said packet network for transmission over said packet network to one or more egress interfaces, said apparatus comprising:
an input for receiving a packet flow obtained from a constant bit rate stream of data; and processing means for dynamically changing a frequency of said packet flow to reduce the degree of correlation between said packet flow and other packet flows over said packet network.

23. The method according to claim 1, further comprising the step of synchronizing first and second clocks coupled respectively to said ingress and egress interfaces of said packet network, for each of a plurality of constant bit rate streams, wherein a rate of said first clock determines a bit rate of a constant bit rate stream arriving at said ingress interface and a rate of said second clock determines a bit rate of a constant bit rate stream sent from said egress interface.

24. The method according to claim 23 further comprising the step of, at the egress interface, calculating a minimum packet transit time over said packet network in each of successive time intervals, and varying said rate of said second clock to maintain a constant value of said minimum packet transit time, whereby frequency and phase synchronization of said first and second clocks is achieved.

25. The method according to claim 23 further comprising the step of, at said egress interface, calculating a mean packet arrival rate over said packet network in each of successive time intervals, and varying said rate of said second clock to maintain a constant value of said mean packet arrival rate, whereby frequency and phase synchronization of said first and second clocks is achieved.

26. The method according to claim 1, further comprising a step of determining clock frequencies of each incoming constant bit rate stream at the ingress interface and changing a frequency of a corresponding packet flow when said frequency differs from a frequency of another incoming constant bit rate stream or packet flow by a value which is less than some predefined value, and/or is not exactly synchronised with a frequency of another incoming constant bit rate stream or packet flow.
